(19) United States
(12) Patent Application Publication
(10) Pub. No.: US 2025/0219550 A1
(43) Pub. Date: Jul. 3, 2025

(54) CONTROL METHOD AND POWER CONVERSION DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Takenori YASUZUMI, Yokohama (JP); Yasuyuki FUJIWARA, Yokohama (JP); Shugo SUZUKI, Hanno (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 18/963,004

(22) Filed: Nov. 27, 2024

(30) Foreign Application Priority Data
Dec. 28, 2023 (JP) 2023-222474

(51) Int. Cl. H02M 7/219; H02M 1/00

(52) U.S. Cl. CPC H02M 7/219; H02M 1/0003

(57) ABSTRACT

According to one embodiment, a control method is provided. The control method includes: precharging, in a state where both of a first switching element and a second switching element in a power conversion device are turned off when the first and second switching elements perform a synchronous rectification operation, one end of the first switching element, the first and second switching elements being half-bridge connected between an input node and an output node, and the power conversion device converting an AC voltage into a DC voltage; and turning on the second switching element after the precharging the one end of the first switching element is completed.

### CROSS-REFERENCE TO RELATED APPLICATIONS

This application is based upon and claims the benefit of priority from Japanese Patent Application No. 2023-222474, filed on Dec. 28, 2023; the entire contents of which are incorporated herein by reference.

### FIELD

Embodiments described herein relate generally to a control method and a power conversion device.

### BACKGROUND

A power conversion device may receive an AC voltage, rectify an electric current according to the received AC voltage, and generate a DC voltage according to the rectified electric current. In the power conversion device, it is desirable to prevent noise from the power conversion device from being input into the AC voltage.

An object of one embodiment is to provide a control method and a power conversion device, which can prevent noise from the power conversion device from being input into an AC voltage.

### BRIEF DESCRIPTION OF THE DRAWINGS

FIG. 1 is a diagram illustrating a configuration of a power conversion device according to an embodiment;

FIG. 2 is a waveform diagram illustrating general operations of the power conversion device according to the embodiment;

FIG. 3 is a diagram illustrating characteristics of a parasitic capacitance of a switching element according to the embodiment;

FIG. 4 is a diagram illustrating a configuration of a precharge circuit according to the embodiment;

FIGS. 5A to 5D are diagrams illustrating operations and current paths of the power conversion device according to the embodiment;

FIGS. 6A to 6D are diagrams illustrating operations and current paths of the power conversion device according to the embodiment; and

FIG. 7 is a waveform diagram illustrating operations of the power conversion device according to the embodiment.

### DETAILED DESCRIPTION

In general, according to one embodiment, a control method is provided. The control method includes: precharging, in a state where both of a first switching element and a second switching element in a power conversion device are turned off when the first and second switching elements perform a synchronous rectification operation, one end of the first switching element, the first and second switching elements being half-bridge connected between an input node and an output node, and the power conversion device converting an AC voltage into a DC voltage; and turning on the second switching element after the precharging the one end of the first switching element is completed.

Exemplary embodiments of a control method and a power conversion device will be explained below in detail with reference to the accompanying drawings. The present invention is not limited to the following embodiments.

### Embodiment

A power conversion device 1 according to an embodiment receives an AC voltage, rectifies an electric current according to the received AC voltage, and generates a DC voltage according to the rectified electric current, but is designed to prevent noise from the power conversion device from being input into the AC voltage.

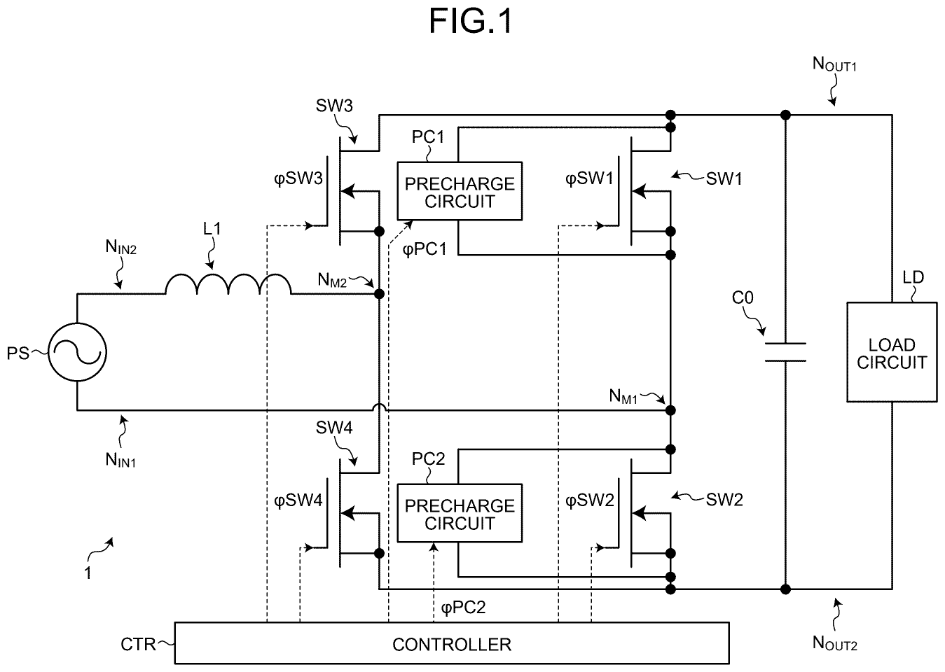

As illustrated in FIG. 1, the power conversion device 1 is connected between an AC power supply PS and a load circuit LD. The power conversion device 1 receives an AC voltage from the AC power supply PS, converts the AC voltage into a DC voltage, and supplies the DC voltage to the load circuit LD. The AC power supply PS may be a system power supply. The load circuit LD may be a DC motor.

The power conversion device 1 includes input nodes N_{IN1} and N_{IN2} and output nodes N_{OUT1} and N_{OUT2}. The input node N_{IN1} is connected to one end of the AC power supply PS, and the input node N_{IN2} is connected to another end of the AC power supply PS. The output node N_{OUT1} is connected to one end of the load circuit LD, and the output node N_{OUT2} is connected to another end of the load circuit LD.

The power conversion device 1 includes a switching element SW1, a switching element SW2, and a controller CTR. The switching element SW1 and the switching element SW2 are half-bridge connected between the input node N_{IN1} and “the output nodes N_{OUT1} and N_{OUT2}”. A node N_{M1} between the switching element SW1 and the switching element SW2 is connected to the input node N_{IN1}.

One end of the switching element SW1 is connected to the output node N_{OUT1}, the other end is connected to the input node N_{IN1} via the node N_{M1}, and its control terminal is connected to the controller CTR. The switching element SW1 is an NMOS transistor, for example. In the switching element SW1, a source is connected to the input node N_{IN1} via the node N_{M1}, a drain is connected to the output node N_{OUT1}, and a gate is connected to the controller CTR.

The switching element SW1 receives a control signal φSW1 from the controller CTR via the control terminal (e.g., gate). In accordance with the control signal φSW1, the switching element SW1 is turned on/off. The switching element SW1 is turned on when the control signal φSW1 is an active level (e.g., high level). The switching element SW1 is turned off when the control signal φSW1 is a non-active level (e.g., low level).

One end of the switching element SW2 is connected to the input node N_{IN1} via the node N_{M1}, the other end is connected to the output node N_{OUT1}, and its control terminal is connected to the controller CTR. The switching element SW2 is an NMOS transistor, for example. In the switching element SW2, a source is connected to the output node N_{OUT1}, a drain is connected to the input node N_{IN1} via the node N_{M}1, and a gate is connected to the controller CTR.

The switching element SW2 receives a control signal φSW2 from the controller CTR via the control terminal (e.g., gate). In accordance with the control signal φSW2, the switching element SW2 is turned on/off. The switching element SW2 is turned on when the control signal φSW2 is the active level (e.g., high level). The switching element SW2 is turned off when the control signal @SW2 is the non-active level (e.g., low level).

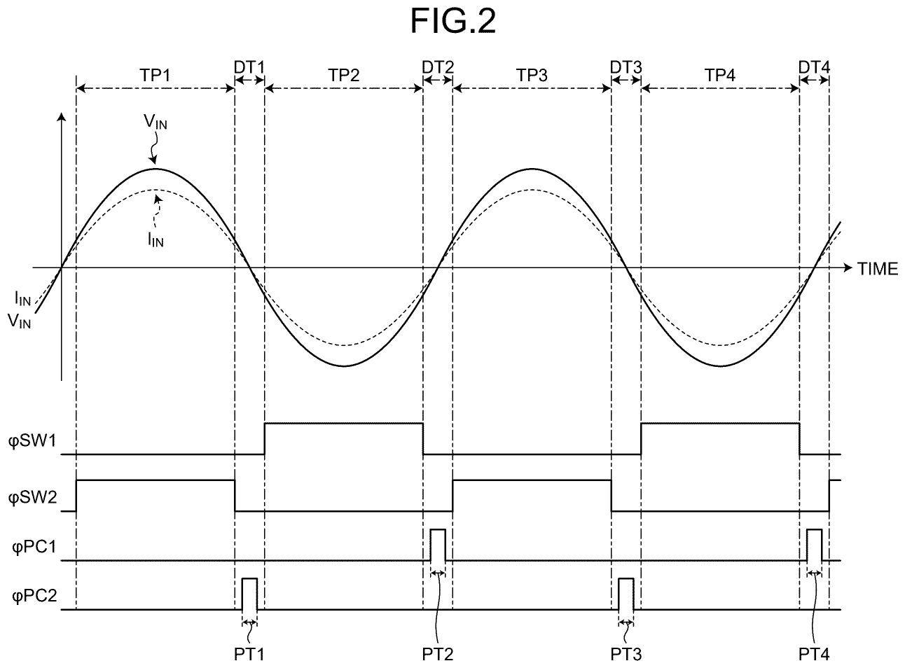

The switching element SW1 and the switching element SW2 perform a synchronous rectification operation under the control by the controller CTR. For example, assuming that an amplitude of an AC voltage V_{IN} from the AC power supply PS is positive when the potential of the input node N_{IN2} is higher than the potential of the input node N_{IN1} and is negative when the potential of the input node N_{IN2} is lower the potential of the input node N_{IN1}, the AC voltage V_{IN} may change in a sinusoidal manner as illustrated with a solid line in FIG. 2. FIG. 2 is a waveform diagram illustrating operations of the power conversion device 1. FIG. 2 illustrates an AC current I_{IN} with a dotted line for reference. The AC current I_{IN} may change in a sinusoidal manner.

In periods TP1 and TP3 in which the amplitude of the AC voltage V_{IN} is positive, the control signal φSW1 is the non-active level (e.g., low level) and the control signal φSW2 is the active level (e.g., high level). According to this, the switching element SW1 is kept in an off state, and the switching element SW2 is kept in an on state. Thus, an electric current flows in the path of the switching element SW2→the node N_{M1}→-the input node N_{IN1}→the AC power supply PS→the input node N_{IN2}.

In periods TP2 and TP4 in which the amplitude of the AC voltage V_{IN} is negative, the control signal φSW1 is the active level (e.g., high level) and the control signal φSW2 is the non-active level (e.g., low level). According to this, the switching element SW1 is kept in an on state, and the switching element SW2 is kept in an off state. Thus, an electric current flows in the path of the input node N_{IN2}→the AC power supply PS→the input node N_{IN1}→the node N_{M1}→the switching element SW1.

Dead times DT1, DT2, DT3, and DT4 in which both of the switching element SW1 and the switching element SW2 are kept in an off state are provided near zero crossing points of the AC voltage V_{IN}. In the dead times DT1, DT2, DT3, and DT4, a parasitic capacitance C_{SW1} of the switching element SW1 and a parasitic capacitance C_{SW2} of the switching element SW2 may be in a substantially discharged state. The parasitic capacitance C_{SW1} is an output capacitance of the switching element SW1. The parasitic capacitance C_{SW2} is an output capacitance of the switching element SW2.

For example, the dead times DT1 and DT3 begin at a timing at which the switching element SW2 is turned off, and then the parasitic capacitance C_{SW2} of the switching element SW2 may be in a substantially discharged state. When the switching element SW1 is turned on at the ending timings of the dead times DT1 and DT3, an electric charge suddenly flows into the parasitic capacitance C_{SW2} of the switching element SW2 that is in a substantially discharged state, and steep potential fluctuation may occur in a voltage V_{OUT} between the output nodes N_{OUT1} and N_{OUT2}. The steep potential fluctuation of the voltage V_{OUT} causes spike noise of a current I_{OUT} flowing in the output nodes N_{OUT1} and N_{OUT2}, and thus electromagnetic noise exceeding tolerance may be emitted.

Similarly, the dead times DT2 and DT4 begin at a timing at which the switching element SW1 is turned off, and then the parasitic capacitance C_{SW1} of the switching element SW1 may be in a substantially discharged state. When the switching element SW2 is turned on at the ending timings of the dead times DT2 and DT4, an electric charge suddenly flows into the parasitic capacitance C_{SW1} of the switching element SW1 that is in a substantially discharged state, and steep potential fluctuation may occur in the voltage V_{OUT} between the output nodes N_{OUT1} and N_{OUT2}. The steep potential fluctuation of the voltage V_{OUT} causes spike noise of the current I_{OUT} flowing in the output nodes N_{OUT1} and N_{OUT2}, and thus electromagnetic noise exceeding tolerance may be emitted.

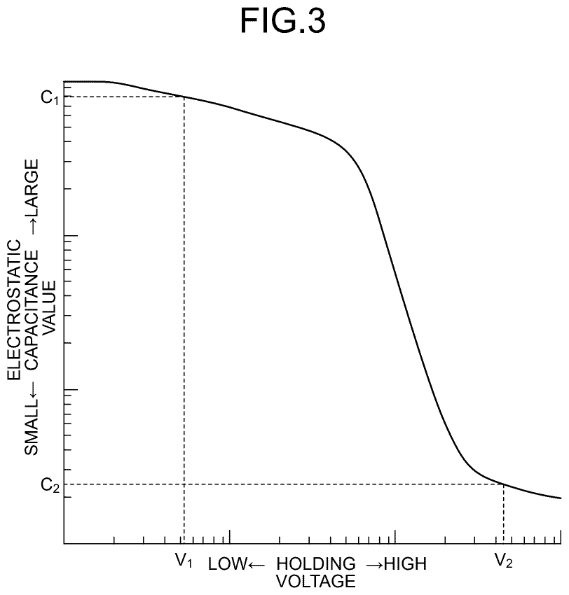

As illustrated in FIG. 3, the parasitic capacitance C_{SW1} of the switching element SW1 may change an electrostatic capacitance value in accordance with a voltage to be held therein. FIG. 3 is a diagram illustrating characteristics of the parasitic capacitance C_{SW1} of the switching element SW1. The parasitic capacitance C_{SW1} has a trend that an electrostatic capacitance value becomes smaller as a holding voltage becomes larger. For example, an electrostatic capacity value is comparatively large C₁ at a holding voltage V₁ that is in a substantially discharged state, and when the switching element SW2 is turned on, an electric charge is easy to flow into the parasitic capacitance CSW1 and the steep potential fluctuation of the parasitic capacitance C_{SW1} is easy to occur. On the other hand, the electrostatic capacity value is comparatively small C₂ at a holding voltage V₂ that is in a substantially fully charged state, and when the switching element SW2 is turned on, an electric charge is hard to flow into the parasitic capacitance C_{SW1} and the steep potential fluctuation of the parasitic capacitance C_{SW1} is hard to occur. The same applies to the parasitic capacitance C_{SW2} of the switching element SW2.

Herein, the power conversion device 1 is configured to cause the switching element SW1 and the switching element SW2 to be prechargeable. The power conversion device 1 further includes a precharge circuit PC1 and a precharge circuit PC2.

The precharge circuit PC1 corresponds to the switching element SW1. At least one end of the precharge circuit PC1 is connected to one end of the switching element SW1. The other end of the precharge circuit PC1 may be connected to the other end of the switching element SW1. Thus, the precharge circuit PC1 can precharge one end of the switching element SW1.

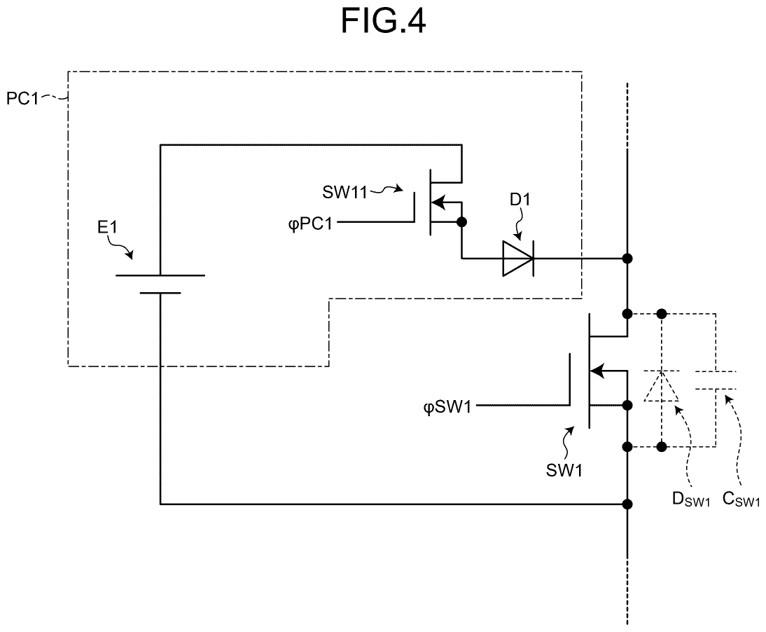

The precharge circuit PC1 may be configured as illustrated in FIG. 4. FIG. 4 is a diagram illustrating a configuration of the precharge circuit PC1.

The precharge circuit PC1 includes a voltage source E1, a switch SW11, and a rectifying element D1. One end of the voltage source E1 is connected to the switch SW11, and the other end is connected to the other end of the switching element SW1. One end of the voltage source E1 may be a high-voltage-side terminal, and the other end may be a low-voltage-side terminal. A voltage generated from the voltage source E1 may be experimentally predetermined in accordance with an amount of electric charge to be precharged at one end of the switching element SW1. One end of the switch SW11 is connected to the voltage source E1, the other end is connected to the rectifying element D1, and its control terminal is connected to the controller CTR (see FIG. 1). The switch SW11 is an NMOS transistor, for example. In the switch SW11, a source is connected to the rectifying element D1, a drain is connected to the voltage source E1, and a gate is connected to the controller CTR. One end of the rectifying element D1 is connected to the switch SW11, and the other end is connected to one end of the switching element SW1. The rectifying element D1 is a diode, for example. In the rectifying element D1, an anode is connected to the switch SW11 and a cathode is connected to one end of the switching element SW1.

The precharge circuit PC2 illustrated in FIG. 1 corresponds to the switching element SW2. At least one end of the precharge circuit PC2 is connected to one end of the switching element SW2. The other end of the precharge circuit PC2 may be connected to the other end of the switching element SW2. Thus, the precharge circuit PC2 can precharge one end of the switching element SW2. The configuration of the precharge circuit PC2 is similar to the configuration (see FIG. 4) of the precharge circuit PC1.

For example, at the timings of the beginning in the dead times DT1 and DT3 illustrated in FIG. 2, the switching element SW2 is turned off in a state where the switching element SW1 is turned off. After the switching element SW2 is turned off, a control signal φPC2 reaches the active level. According to this, the precharge circuit PC2 starts to supply an electric charge to one end of the switching element SW2, and starts to precharge one end of the switching element SW2. In other words, the parasitic capacitance C_{SW2} begins to be charged. Depending on the passage of a time PT1 or PT3 from the start of supply of electric charge, the control signal φPC2 reaches the non-active level. The times PT1 and PT3 are shorter than the respective dead times DT1 and DT3. The times PT1 and PT3 are experimentally predetermined as times required for the precharging. According to this, the supply of electric charge to one end of the switching element SW2 is terminated, and the precharging of one end of the switching element SW2 is terminated. In other words, the charging of the parasitic capacitance C_{SW2} is terminated.

Thus, when the switching element SW1 is turned on at the timings of the end of the dead times DT1 and DT3, it is possible to suppress an amount of electric charge flowing into the parasitic capacitance C_{SW2} of the switching element SW2 to suppress potential fluctuation of the parasitic capacitance C_{SW2}. As a result, it is possible to suppress spike noise of the current I_{OUT} flowing in the output nodes N_{OUT1} and N_{OUT2} so as to suppress electromagnetic noise.

Similarly, at the timings of the beginning in the dead times DT2 and DT4, the switching element SW1 is turned off in a state where the switching element SW2 is turned off. After the switching element SW1 is turned off, a control signal φPC1 reaches the active level. According to this, the precharge circuit PC1 starts to supply an electric charge to one end of the switching element SW1, and starts to precharge one end of the switching element SW1. In other words, the parasitic capacitance C_{SW1} begins to be charged. Depending on the passage of a time PT2 or PT4 from the start of supply of electric charge, the control signal φPC1 reaches the non-active level. The times PT2 and PT4 are shorter than the respective dead times DT2 and DT4. The times PT2 and PT4 are experimentally predetermined as times required for the precharging. According to this, the supply of electric charge to one end of the switching element SW1 is terminated, and the precharging of one end of the switching element SW1 is terminated. In other words, the charging of the parasitic capacitance C_{SW1} is terminated.

Thus, when the switching element SW2 is turned on at the timings of the end of the dead times DT2 and DT4, it is possible to suppress an amount of electric charge flowing into the parasitic capacitance C_{SW1} of the switching element SW1 to suppress potential fluctuation of the parasitic capacitance C_{SW1}. As a result, it is possible to suppress spike noise of the current I_{OUT} flowing in the output nodes N_{OUT1} and N_{OUT2} so as to suppress electromagnetic noise.

The power conversion device 1 may be configured to perform power factor improvement. As a configuration for performing power factor improvement, the power conversion device 1 may include an induction element L1, a switching element SW3, and a switching element SW4.

The switching element SW3 and the switching element SW4 are half-bridge connected between the input node N_{IN2} and “the output nodes N_{OUT1} and N_{OUT2}”. A node N_{M2} between the switching element SW3 and the switching element SW4 is connected to the input node N_{IN2} via the induction element L1.

One end of the switching element SW3 is connected to the output node N_{OUT1}, the other end is connected to the input node N_{IN2} via the node N_{M2}, and its control terminal is connected to the controller CTR. The switching element SW3 is an NMOS transistor, for example. In the switching element SW3, a source is connected to the input node N_{IN2} via the node N_{M2}, a drain is connected to the output node N_{OUT1}, and a gate is connected to the controller CTR.

The switching element SW3 receives a control signal φSW3 from the controller CTR via the control terminal (e.g., gate). The switching element SW3 is turned on/off in accordance with the control signal φSW3. The switching element SW3 is turned on when the control signal φSW3 is an active level (e.g., high level). The switching element SW3 is turned off when the control signal φSW3 is a non-active level (e.g., low level).

One end of the switching element SW4 is connected to the input node N_{IN2} via the node N_{M2}, the other end is connected to the output node N_{OUT2}, and its control terminal is connected to the controller CTR. The switching element SW4 is an NMOS transistor, for example. In the switching element SW4, a source is connected to the output node N_{OUT2}, a drain is connected to the input node N_{IN2} via the node N_{M2}, and a gate is connected to the controller CTR.

The switching element SW4 receives a control signal φSW4 from the controller CTR via the control terminal (e.g., gate). The switching element SW4 is turned on/off in accordance with the control signal φSW4. The switching element SW4 is turned on when the control signal φSW4 is the active level (e.g., high level). The switching element SW4 is turned off when the control signal φSW4 is the non-active level (e.g., low level).

The switching element SW3 and the switching element SW4 perform a power factor improvement operation under the control by the controller CTR. For example, the switching element SW3 and the switching element SW4 respectively perform a switching operation at a cycle faster than the switching element SW1 and the switching element SW2, and alternately repeat accumulation of electric energy from the AC power supply PS into the induction element L1 and accumulation of electric energy from the induction element L1 into a capacitive element C0. This results in bringing a phase of the DC voltage and a phase of the DC current closer together to achieve power factor improvement.

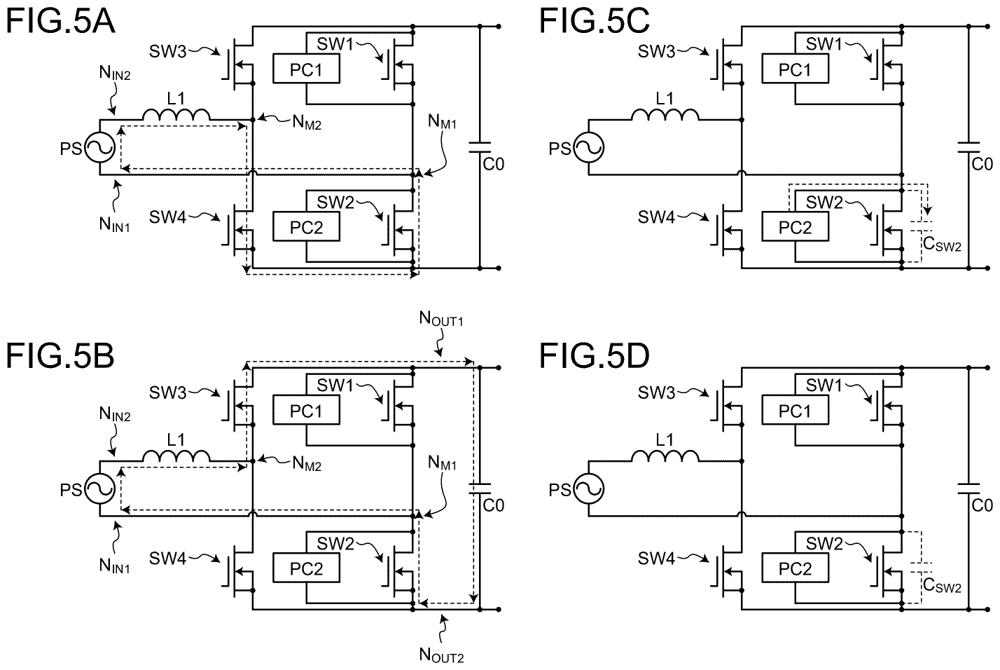

In the periods TP1 and TP3 in which the amplitude of the AC voltage V_{IN} is positive, the operation illustrated in FIG. 5A and the operation illustrated in FIG. 5B are alternately repeated. In FIG. 5A, the switching elements SW1 and SW3 are kept in an off state, and the switching elements SW2 and SW4 are kept in an on state. An electric current flows in the path of the switching element SW2→the node N_{M1}→the input node N_{IN1}→the AC power supply PS→the input node N_{IN2}→the induction element L1→the node N_{M2}→the switching element SW4→the switching element SW2, and electric energy is accumulated in the induction element L1.

In FIG. 5B, the switching elements SW1 and SW4 are kept in an off state, and the switching elements SW2 and SW3 are kept in an on state. An electric current flows in the path of the switching element SW2→the node N_{M1}→the input node N_{IN1}→the AC power supply PS→the input node N_{IN2}→the induction element L1→the node N_{M2}→the switching element SW3→the output node N_{OUT1}→the capacitive element C0→the output node N_{OUT2}→the switching element SW2, and electric energy is transferred from the induction element L1 to the capacitive element C0 to be accumulated in the capacitive element C0.

In the dead times DT1 and DT3 after that, the operation illustrated in FIG. 5C and the operation illustrated in FIG. 5D are sequentially performed. In FIG. 5C, all of the switching elements SW1 to SW4 are kept in an off state and the amplitude of the AC voltage V_{IN} is near the zero crossing point, and an electric current does not substantially flow, including a reflux current. At this time, as illustrated by a dotted arrow, the precharge circuit PC2 supplies an electric charge to one end of the switching element SW2 to precharge one end of the switching element SW2. Thus, the parasitic capacitance C_{SW2} of the switching element SW2 is charged with an electric charge to increase a holding voltage. In FIG. 5D, the precharge circuit PC2 terminates the supply of electric charge to one end of the switching element SW2 to terminate the precharging of one end of the switching element SW2. Thus, the parasitic capacitance C_{SW2} of the switching element SW2 holds an electric charge to keep the holding voltage.

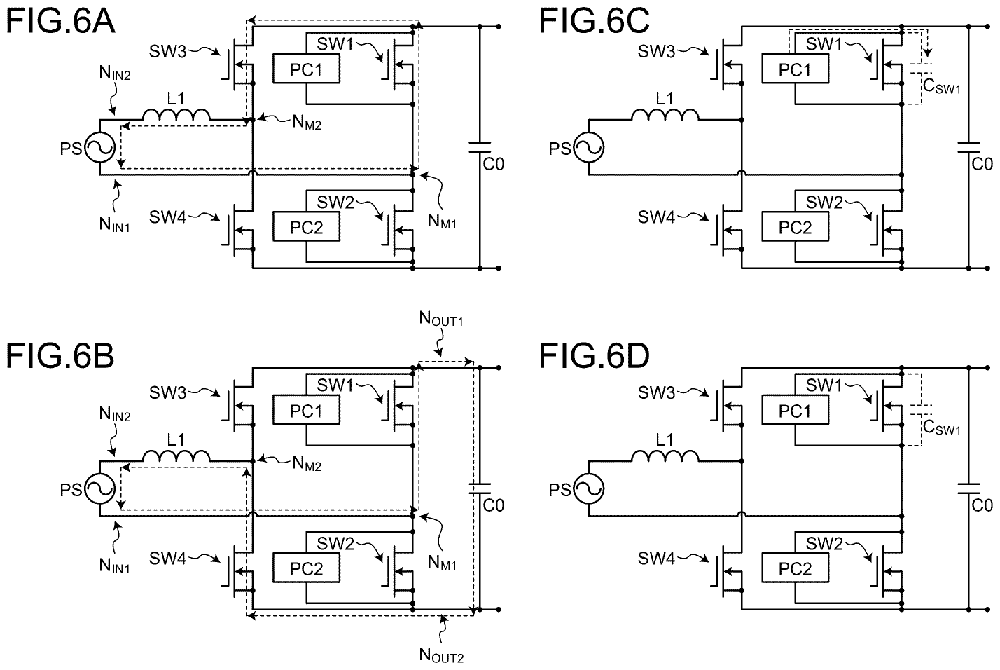

In the periods TP2 and TP4 in which the amplitude of the AC voltage V_{IN} is negative, the operation illustrated in FIG. 6A and the operation illustrated in FIG. 6B are alternately repeated. In FIG. 6A, the switching elements SW2 and SW4 are kept in an off state, and the switching elements SW1 and SW3 are kept in an on state. An electric current flows in the path of the switching element SW1→the switching element SW3→the node N_{M2}→the induction element L1→the input node N_{IN2}→the AC power supply PS→the input node N_{IN1}→the node N_{M1}→the switching element SW1, and electric energy is accumulated in the induction element L1.

In FIG. 6B, the switching elements SW2 and SW3 are kept in an off state, and the switching elements SW1 and SW4 are kept in an on state. An electric current flows in the path of the switching element SW1→the output node N_{OUT1}→the capacitive element C0→the output node N_{OUT2}→the switching element SW4→the node N_{M2}→the induction element L1—the input node N_{IN2}→the AC power supply PS→the input node N_{IN1}→the node N_{M1}→the switching element SW1, and electric energy is transferred from the induction element L1 to the capacitive element C0 to be accumulated in the capacitive element C0.

In the dead times DT2 and DT4 after that, the operation illustrated in FIG. 6C and the operation illustrated in FIG. 6D are sequentially performed. In FIG. 6C, all of the switching elements SW1 to SW4 are kept in an off state and the amplitude of the AC voltage V_{IN} is near the zero crossing point, and an electric current does not substantially flow, including a reflux current. At this time, as illustrated by a dotted arrow, the precharge circuit PC1 supplies an electric charge to one end of the switching element SW1 to precharge one end of the switching element SW1. Thus, the parasitic capacitance C_{SW1} of the switching element SW1 is charged with an electric charge to increase a holding voltage. In FIG. 6D, the precharge circuit PC1 terminates the supply of electric charge to one end of the switching element SW1 to terminate the precharging of one end of the switching element SW1. Thus, the parasitic capacitance C_{SW1} of the switching element SW1 holds an electric charge to keep the holding voltage.

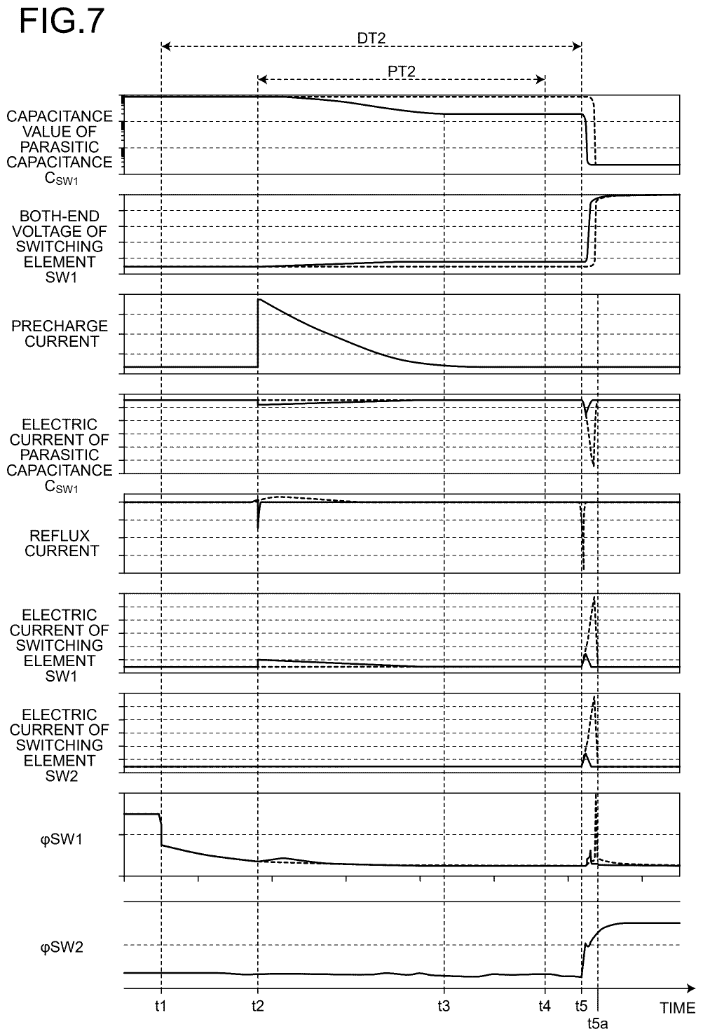

Next, detailed operations of the power conversion device will be described with reference to FIG. 7. FIG. 7 is a waveform diagram illustrating operations of the power conversion device 1, and mainly illustrates operations in the dead time DT2. FIG. 7 illustrates temporal changes of a capacitance value of the parasitic capacitance C_{SW1} of the switching element SW1, a both-end voltage of the switching element SW1, a precharge current supplied from the precharge circuit PC1, an electric current flowing into the parasitic capacitance C_{SW1} of the switching element SW1, a reflux current flowing in a parasitic diode of the switching element SW1, an electric current flowing through both ends of the switching element SW1, an electric current flowing through both ends of the switching element SW2, the control signal φSW1 from the controller CTR to the switching element SW1, and the control signal φSW2 from the controller CTR to the switching element SW2.

Just before a timing t1, the control signal φSW2 is kept at a non-active level, and the switching element SW2 is kept in an off state.

At the timing t1, the control signal SW1 transitions from an active level to the non-active level to turn off the switching element SW1. According to this, the dead time DT2 is started. After that, the switching element SW1 is kept in the off state.

At a timing t2, the control signal φPC1 not illustrated transitions from the non-active level to the active level, and the precharge circuit PC1 begins to supply the precharge current. At this time, because the amplitude of the AC voltage V_{IN} is substantially near the zero crossing point (see FIG. 2), the reflux current does not substantially flow, and an electric current according to the precharge current efficiently flows from the precharge circuit PC1 to the parasitic capacitance C_{SW1} of the switching element SW1. According to this, the parasitic capacitance C_{SW1} begins to be charged, and the capacitance value begins to decrease as the holding voltage begins to increase.

At a timing t3, when the parasitic capacitance C_{SW1} reaches a substantially fully charged state, the holding voltage begins to keep a substantially constant value, and the capacitance value begins to keep a substantially constant value.

When reaching a timing t4 at which the time PT2 has passed from the timing t2, the control signal φPC1 not illustrated transitions from the active level to the non-active level, and the precharge circuit PC1 finishes supplying the precharge current. At this time, the parasitic capacitance C_{SW1} is in a substantially fully charged state, and the holding voltage keeps a substantially constant value and the capacitance value keeps a substantially constant value.

At a timing t5, the control signal φSW2 transitions from the non-active level to the active level, and the switching element SW2 is turned on. At this time, because the parasitic capacitance C_{SW1} of the switching element SW1 is in a substantially fully charged state, it is possible to suppress an amount of electric charge flowing into the parasitic capacitance C_{SW1} of the switching element SW1 to suppress potential fluctuation of the parasitic capacitance C_{SW1}. As a result, it is possible to suppress spike noise of the current I_{OUT} flowing in the output nodes N_{OUT1} and N_{OUT2} so as to suppress electromagnetic noise.

Note that a case where the precharging to the parasitic capacitance C_{SW1} of the switching element SW1 is not performed is illustrated with a dotted line for comparison. For example, when comparing a dotted waveform and a solid waveform for an electric current flowing into the parasitic capacitance C_{SW1} of the switching element SW1, it is confirmed that an amount of electric charge flowing into the parasitic capacitance C_{SW1} can be suppressed by performing the precharging.

As described above, according to the embodiment, in the power conversion device 1, the precharge circuit PC1 precharges one end of the switching element SW1 in a state where both of the switching element SW1 and the switching element SW2 are turned off, for example, and turns on the switching element SW2 after the precharging by the precharge circuit PC1 is completed. Thus, it is possible to suppress an amount of electric charge flowing into the parasitic capacitance C_{SW1} of the switching element SW1 to suppress potential fluctuation of the parasitic capacitance C_{SW1}. As a result, it is possible to suppress spike noise of the current I_{OUT} flowing in the output nodes N_{OUT1} and N_{OUT2} so as to suppress electromagnetic noise.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control method comprising:
precharging, in a state where both of a first switching element and a second switching element in a power conversion device are turned off when the first and second switching elements perform a synchronous rectification operation, one end of the first switching element, the first and second switching elements being half-bridge connected between an input node and an output node, and the power conversion device converting an AC voltage into a DC voltage; and
turning on the second switching element after the precharging the one end of the first switching element is completed.

2. The control method according to claim 1, further comprising:
precharging, in a second state where both of the first switching element and the second switching element are turned off, one end of the second switching element; and
turning on the first switching element after the precharging the one end of the second switching element is completed.

3. The control method according to claim 1, wherein
the precharging the one end of the first switching element includes:
turning off the first switching element in a state where the second switching element is turned off;
starting to supply electric charge to the one end of the first switching element after the first switching element is turned off; and
terminating the supply of electric charge to the one end of the first switching element depending on passage of a first time from the starting to supply the electric charge.

4. The control method according to claim 2, wherein
the precharging the one end of the first switching element includes:
turning off the first switching element in a state where the second switching element is turned off;
starting to supply electric charge to the one end of the first switching element after the first switching element is turned off; and
terminating the supply of electric charge to the one end of the first switching element depending on passage of a first time from the starting to supply the electric charge, and
the precharging the one end of the second switching element includes:
turning off the second switching element in a state where the first switching element is turned off;
starting to supply electric charge to the one end of the second switching element after the second switching element is turned off; and
terminating the supply of electric charge to the one end of the second switching element depending on passage of a second time from the starting to supply the electric charge.

5. The control method according to claim 1, wherein
a third switching element and a fourth switching element in the power conversion device perform a power factor improvement operation in parallel with the synchronous rectification operation, the third and fourth switching elements being connected in parallel with the first and second switching elements between the input node and the output node.

6. A power conversion device comprising:
a first switching element connected between a first input node and a first output node, the first input node being input with an AC voltage;
a second switching element connected between the first input node and a second output node, the second switching element performing a synchronous rectification operation together with the first switching element;
a first precharge circuit configured to be able to precharge one end of the first switching element; and
a second precharge circuit configured to be able to precharge one end of the second switching element, wherein
the power conversion device causes the first precharge circuit to precharge the one end of the first switching element in a state where both of the first and second switching elements are turned off, and turns on the second switching element after the precharging by the first precharge circuit is completed.

7. The power conversion device according to claim 6, wherein
the power conversion device:
precharges, in a second state where both of the first switching element and the second switching element are turned off, the one end of the second switching element; and
turns on the first switching element after the precharging the one end of the second switching element is completed.

8. The power conversion device according to claim 6, wherein
the power conversion device:
at a first timing, turns off the first switching element in a state where the second switching element is turned off;
at a second timing after the first timing, starts to supply electric charge to the one end of the first switching element; and
at a third timing at which a first time has elapsed from the second timing, terminates the supply of electric charge to the one end of the first switching element.

9. The power conversion device according to claim 7, wherein
the power conversion device:
at a first timing, turns off the first switching element in a state where the second switching element is turned off;
at a second timing after the first timing, starts to supply electric charge to the one end of the first switching element;
at a third timing at which a first time has elapsed from the second timing, terminates the supply of electric charge to the one end of the first switching element;
at a fourth timing, turns off the second switching element in a state where the first switching element is turned off;
at a fifth timing after the fourth timing, starts to supply electric charge to the one end of the second switching element; and
at a sixth timing at which a second time has elapsed from the fifth timing, terminates the supply of electric charge to the one end of the second switching element.

10. The power conversion device according to claim 6, further comprising:
a third switching element connected between a second input node and the first output node, the second input node being input with the AC voltage; and
a fourth switching element connected between the second input node and a second output node, the fourth switching element performing a power factor improvement operation together with the third switching element, wherein
the third switching element and the fourth switching element perform the power factor improvement operation in parallel with the synchronous rectification operation.
